(19) United States
(12) Patent Application Publication
(10) Pub. No.: US 2026/0211206 A1
(43) Pub. Date: Jul. 23, 2026

(54) LENS MODULE

(71) Applicant: SAMSUNG ELECTRO-MECHANICS CO., LTD., Suwon-si (KR)

(72) Inventors: Seong Chan PARK, Suwon-si (KR); Jung Eun NOH, Suwon-si (KR); Seung Mi LEE, Suwon-si (KR); Yee Na SHIN, Suwon-si (KR); Sang Hyun KWON, Suwon-si (KR); Seon Ki KIM, Suwon-si (KR); Min Ji KIM, Suwon-si (KR)

(73) Assignee: SAMSUNG ELECTRO-MECHANICS CO., LTD., Suwon-si (KR)

(21) Appl. No.: 19/393,812

(22) Filed: Nov. 19, 2025

(30) Foreign Application Priority Data
Jan. 17, 2025 (KR) 10-2025-0007225

(51) Int. Cl. G02B 7/02; G02B 1/04; G03B 17/08

(52) U.S. Cl. CPC G02B 7/026; G02B 1/041; G02B 7/021; G03B 17/08

(57) ABSTRACT

A lens module is provided. The lens module includes a lens barrel including a metal layer, a lens unit including a plurality of lenses disposed within the lens barrel and having an effective diameter and a rib, a metal ring disposed within the rib of at least one lens of the plurality of lenses, and at least a portion of the metal ring extends outside the lens, and a solder layer disposed between the metal layer and the metal ring.

### CROSS-REFERENCE TO RELATED APPLICATIONS

This application claims benefit under 35 USC § 119(a) of Korean Patent Application No. 10-2025-0007225 filed on Jan. 17, 2025, in the Korean Intellectual Property Office, the entire disclosure of which is incorporated herein by reference for all purposes.

### BACKGROUND

### 1. Field

The following description relates to a lens module.

### 2. Description of Related Art

Automotive camera modules have recently been implemented as a standard automotive component for various operations such as, but not limited to, Advanced Driver Assistance System (ADAS), autonomous driving, and parking assistance.

A lens module included in the automotive camera module is a key component that collects light to capture images and perform operations such as, but not limited to, object recognition and distance measurement based on these images.

Since the lens modules may be exposed to the external environment, and are mounted on vehicles, moisture may penetrate thereinto, depending on external environmental factors such as weather or temperature changes, which may cause problems such as performance degradation or lens deformation due to moisture condensation, and thus there is a demand for lens modules with improved waterproofing operations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a lens module includes a lens barrel including a metal layer; a lens unit, disposed in the lens barrel, and including a plurality of lenses having an effective diameter and a rib; a metal ring disposed within the rib of at least one lens of the plurality of lenses, and at least a portion of the metal ring extends from an external side of the at least one lens; and a solder layer disposed between the metal layer and the metal ring.

The solder layer may be continuously disposed along a periphery of the metal ring.

The metal layer may be disposed within the lens barrel and at least a portion of the metal layer is exposed externally of the lens barrel.

The lens unit may include a foremost lens that is disposed closest to an object side and a rearmost lens that is disposed closest to an image sensor side.

At least one of the foremost lens and the rearmost lens may be a glass lens.

The lens unit may further include at least one intermediate lens that is disposed between the foremost lens and the rearmost lens.

The intermediate lens may include a plastic lens.

A gap that is formed between the lens barrel and the at least one lens may be sealed by the metal layer, the metal ring, and the solder layer, which forms a coupling between the metal layer and the metal ring.

The metal layer may be disposed on an internal surface of the lens barrel.

The metal layer may be disposed on an external surface of the lens barrel.

The metal ring may extend in a direction perpendicular to an optical axis.

The metal ring may extend in an optical axis direction.

The metal ring may extend in an optical axis direction, and may be further bent in a direction perpendicular to the optical axis.

The metal layer and the metal ring may respectively include at least one of Ni, Cu, SUS, and Al.

In a general aspect, a lens module includes a lens barrel formed of metal material; a lens disposed in the lens barrel and including an effective diameter and a rib; and a metal ring disposed within the rib, and at least a portion of the metal ring extends from an external side of the lens; wherein a solder layer coupling may be formed between the lens barrel and the metal ring.

The lens barrel may be formed of at least one metal among Ni, Cu, SUS, and Al.

Other features and aspects will be apparent from the following detailed description, the drawings, and the claims.

### BRIEF DESCRIPTION OF DRAWINGS

FIG. 1 illustrates a perspective view of an example lens module, in accordance with one or more embodiments.

FIG. 2 illustrates a cross-sectional view taken along line I-I′ of FIG. 1.

FIG. 3 illustrates a perspective view of a second lens with a metal ring coupled thereto.

FIG. 4 illustrates a cross-sectional view taken along line II-II′ of FIG. 3.

FIG. 5 illustrates a schematic drawing illustrating a form in which a lens and a lens barrel may be coupled and sealed by a solder layer.

FIG. 6 illustrates a modified example of the rearmost lens of FIG. 4.

FIG. 7 illustrates a modified example of the rearmost lens of FIG. 4.

FIG. 8 illustrates a modified example of a lens module of FIG. 2.

FIG. 9 illustrates a modified example of the lens module of FIG. 2.

FIG. 10 illustrates a modified example of the lens module of FIG. 2.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

In the one or more examples, the foremost lens refers to a lens closest to an object side, and the rearmost lens refers to a lens closest to an image side (or sensor side). The last lens may include a lens adjacent to the image sensor. Additionally, the term “object-side surface” may refer to a surface of the lens facing toward the object side with respect to an optical axis, and the term “sensor-side surface” may refer to a surface of the lens facing toward the sensor side with respect to the optical axis.

Any configuration included in an embodiment of the embodiments described in the specification may also be included in other embodiments unless stated otherwise.

One or more examples may provide a lens module in which a path through which moisture may penetrate between a lens and a lens barrel is sealed, thereby minimizing moisture penetrating into the inside of the lens barrel.

One or more examples may provide a lens module in which lens deformation inside a lens barrel due to moisture penetration may be minimized.

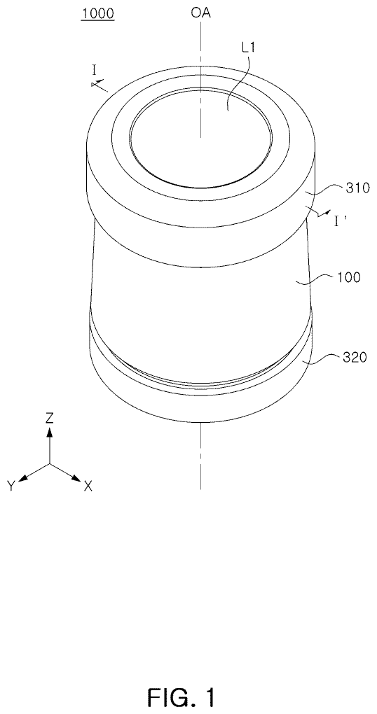

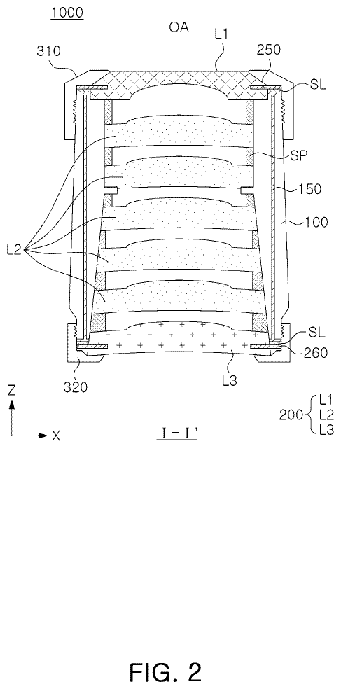

Referring to FIG. 1 and FIG. 2, a lens module 1000, in accordance with one or more embodiments, may include a lens barrel 100 and a lens unit 200 disposed within the lens barrel 100, and having a plurality of lenses L1, L2, and L3. The lens barrel 100 may include a metal layer 150, and among a plurality of lenses L1, L2, and L3, the foremost lens L1 and the rearmost lens L3 may each respectively include a metal ring 250 and a metal ring 260 disposed along the periphery of the respective lens, and the internal space of the lens barrel 100 may be sealed by coupling the metal layer 150 and the metal rings 250 and 260 by a solder layer SL. The lens module 1000, in accordance with one or more embodiments, may have the sealing structure, thereby preventing moisture penetration even when exposed externally, and may reduce a risk of causing problems such as deterioration of image quality due to moisture condensation or lens deformation caused by the presence of moisture.

Hereinafter, main components configuring the lens module 1000, in accordance with one or more embodiments, will be described in detail with reference to the drawings.

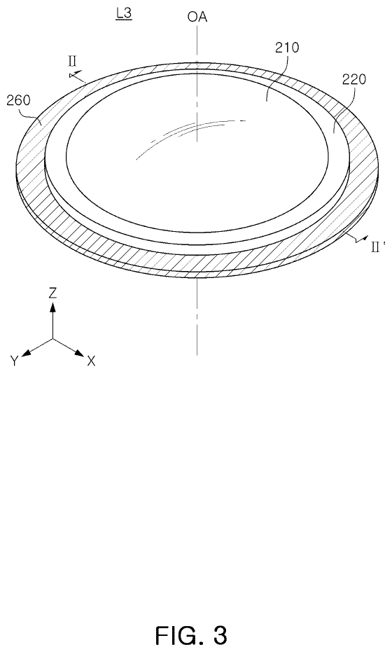

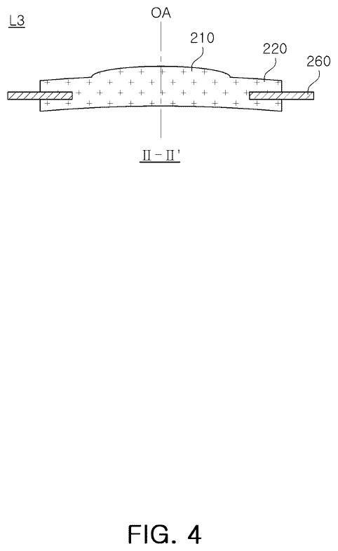

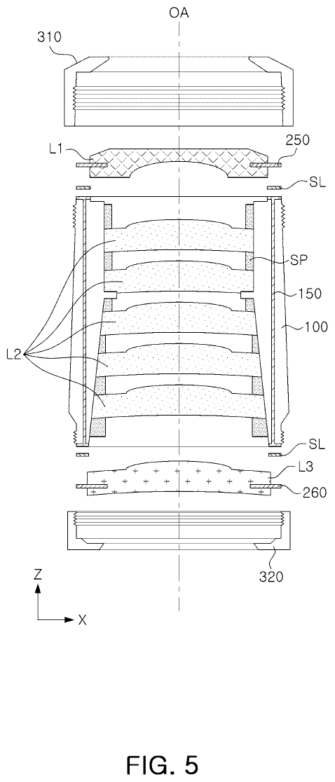

FIG. 1 is a perspective view of the lens module 1000, in accordance with one or more embodiments. FIG. 2 is a cross-sectional view taken along line I-I′ of FIG. 1. FIG. 3 is a perspective view of the rearmost lens L3 to which a metal ring 260 is coupled. FIG. 4 is a cross-sectional view taken along line II-II′ of FIG. 3. FIG. 5 is a schematic drawing illustrating a form in which the lenses L1 and L3 and the lens barrel 100 are coupled and sealed by a solder layer SL.

Referring to FIGS. 1 to 5, the lens module 1000, in accordance with one or more embodiments, may include the lens barrel 100 including the metal layer 150, and the lens unit 200 disposed in the lens barrel 100 and having the plurality of lenses L1, L2, and L3. Additionally, the lens module may further include a first lens cap 310 that fixes, to the lens barrel 100, the foremost lens L1 closest to the object side among the plurality of lenses, and a second lens cap 320 disposed opposite to the foremost lens L1 that fixes, to the lens barrel 100, the rearmost lens L3 closest to the image sensor side.

Referring to FIGS. 1 and 2, the lens barrel 100 of the present embodiment may have an internal space and a cylindrical shape that extends in the optical axis OA direction, that is, a hollow cylindrical form. Additionally, the shape of the lens barrel 100 may be appropriately modified according to a size and shape of the lens unit 200 disposed inside. For example, when a diameter of the rearmost lens L3 is greater than a diameter of the foremost lens L1 as in the present embodiment, an internal space of the lens barrel 100 may also be formed to have a greater diameter at a lower surface than at an upper surface, but it is not limited thereto.

A screw thread that fixes the lens caps 310 and 320 may be formed on an external side surface of the lens barrel 100, and the screw thread on the external side surface of the lens barrel 100 may be engaged with the screw thread on an internal side surface of the respective lens caps 310 and 320 to be coupled through rotation.

In a non-limited example, the lens barrel 100 of the present embodiment may be formed of a plastic material, for example, the lens barrel 100 may be formed of a material such as Polycarbonate (PC), Polybutylene Terephthalate (PBT), Polyamide (PA), Acrylonitrile Butadiene Styrene (ABS), or the like. However, the one or more examples are not limited thereto.

Referring to FIG. 2, the lens barrel 100, in accordance with one or more embodiments, may include a metal layer 150. The metal layer 150 of the present embodiment may be configured to seal the inside of the lens barrel 100 by coupling through the metal rings 250 and 260 of the lenses L1 and L3 and a solder layer SL described later.

The metal layer 150 may be disposed inside the lens barrel 100, and at least a portion of the metal layer 150 may be exposed externally of the lens barrel 100. That is, the metal layer 150 of the present embodiment may be inserted inside of the lens barrel 100 and may be disposed so that a portion of the metal layer 150 may be exposed respectively at at least one of the top and bottom of the lens barrel 100. A region exposed externally of the lens barrel 100 in the metal layer 150 may be coupled through the metal rings 250 and 260 inserted into a rib 220 of the lenses L1 and L3 and the solder layer SL.

In a non-limited example, the metal layer 150 may include at least one of Ni, Cu, SUS, Al, Mg, and Ti, and the lens barrel 100 including the metal layer 150, that is, the lens barrel 100 integrated with the metal layer 150, may be formed through double injection molding using the metal component and a plastic resin component. However, he examples are not limited thereto, and the metal layer 150 may be disposed along the internal surface and/or external surface of the lens barrel 100 by metal coating on a plastic resin. Additionally, a method of forming the lens barrel 100 of a metal material, or a metal coating a polymer through plating may also be implemented.

Referring to FIGS. 2 to 4, the lens unit 200 of the one or more examples may be disposed in the internal space of the lens barrel 100 and may include a plurality of lenses L1, L2, and L3 having an effective diameter 210 and the rib 220.

The lens unit 200 may include the foremost lens L1 disposed closest to an object side and the rearmost lens L3 disposed closest to an image sensor side, and may further include at least one intermediate lens L2 disposed between the foremost lens L1 and the rearmost lens L3. The number and shape of the intermediate lens (or lenses) L2 illustrated in FIG. 2 are examples, and the scope of the one or more examples are not limited thereto, and the lens unit 200 of the one or more examples may include three or more lenses L1, L2, and L3 aligned in the optical axis OA direction. For example, when the intermediate lens L2 has a range of 1 to 9 lenses, the lens unit 200 may include a range of 3 to 11 lenses. However, the one or more examples are not limited thereto.

Additionally, although the rearmost lens L3 in FIG. 2 is illustrated as the lens having the greatest diameter, is the examples are not limited thereto, and a diameter of the foremost lens L1 or a diameter of the intermediate lens L2 may be formed to be the greatest as needed.

Referring to FIG. 3, the lenses L1, L2, and L3 of the one or more examples may include the effective diameter 210 and the rib 220. The effective diameter 210 may be a region that transmits light from the lenses L1, L2, and L3 and performs an optical operation, and the rib 220 may be a peripheral region of the effective diameter 210 and may have a configuration for coupling between the lens barrel 100 and the lenses L1, L2, and L3.

Referring to FIG. 2, in an example, a spacer SP may be disposed between two adjacent lenses to maintain a gap between the lenses. In an example, the spacer SP may be disposed to be less than the total number of the plurality of lenses L1, L2, and L3 included in the lens unit 200, and may be disposed to contact the ribs 220 of two adjacent lenses in the optical axis OA direction. The spacer SP may also have an operation of absorbing or blocking light deviating from the effective optical path.

In an example, at least one of the foremost lens L1 and the rearmost lens L3 of the one or more examples may be a glass lens. Preferably, each of the foremost lens L1 and the rearmost lens L3 disposed at both side openings of the lens barrel 100, may be a glass lenses. In this example, moisture penetration through the lenses L1 and L3 may be suppressed, as compared to the example of plastic lenses.

Additionally, at least one of the intermediate lenses L2 of one or more examples may be a plastic lens. In the example of the intermediate lens L2, which is less related to the sealing structure inside the lens barrel 100, effects such as weight reduction and improved impact resistance may be expected by forming it with a plastic material.

Through this structure, a path for moisture to penetrate into the lens barrel 100 through the foremost lens L1 or the rearmost lens L3 may be effectively blocked, thereby preventing deformation of the intermediate lens L2.

Referring to FIGS. 2 to 4, each of the foremost lens L1 and the rearmost lens L3 of the one or more examples may include the metal rings 250 and 260. The metal rings 250 and 260 may have a configuration for coupling with the metal layer 150 of the lens barrel 100 and sealing the internal space of the lens barrel 100 through this coupling, and may be integrally formed with the lenses L1 and L3.

A first metal ring 250 may be disposed in a ring shape along a periphery of the foremost lens L1, and a second metal ring 260 may be disposed in a ring shape along a periphery of the rearmost lens L3.

The metal rings 250 and 260 of the one or more examples may be disposed within the rib 220, and at least a portion of the metal rings 250 and 260 may extend outside the lenses L1 and L3. Specifically, some regions of the first metal ring 250 may be inserted into the rib 220 of the foremost lens L1, and the remaining regions may be exposed externally of the foremost lens L1. Additionally, some regions of the second metal ring 260 may be inserted into the rib 220 of the rearmost lens L3, and some regions may be exposed externally of the rearmost lens L3.

Additionally, the metal rings 250 and 260 of the one or more examples may extend in a direction perpendicular to the optical axis OA. That is, the metal rings 250 and 260 may have a ring-shaped configuration in which a portion extends in an external direction from the rib 220 around the lenses L1 and L3 in the X-Y plane.

The respective metal rings 250 and 260 may be a metal material including, as only examples, at least one of Ni, Cu, SUS, Al, Mg, and Ti.

The metal rings 250 and 260 of the one or more examples may be disposed in the rib 220, and may be spaced apart from the effective diameter 210, thereby minimizing influence on an optical performance of the lens unit 200 while improving waterproof and moisture-proof effects of the lens module 1000.

An internal diameter side region of the metal rings 250 and 260 may be disposed to be inserted into the rib 220, and an external diameter side region may be disposed to be exposed externally of the lenses L1 and L3. When forming the lenses L1 and L3 through molding or injection, a ring-shaped metal plate may be added and formed together with the lenses L1 and L3, thereby forming the metal rings 250 and 260 integrated with the lenses L1 and L3.

However, the one or more examples are not limited thereto, and the metal rings 250 and 260 may be bonded to the separately formed lenses L1 and L3 through a glass sealant. For example, a glass sealant having a composition such as 40SiO₂-54B₂O₃-4Na₂O-2Al₂O₃ may be used for bonding between the lenses L1 and L3 and the metal rings 250 and 260.

Referring to FIGS. 2 and 5, the lens module 1000, in accordance with one or more embodiments, may include the solder layer SL disposed between the metal layer 150, which is inserted into the lens barrel 100, and the respective metal rings 250 and 260 inserted into the lenses L1 and L3. The solder layer SL may have a configuration to seal an internal space of the lens barrel 100 to prevent moisture penetration.

The solder layer SL may be disposed continuously along a periphery of the metal rings 250 and 260. That is, the solder layer SL may be disposed in a closed-curve shape corresponding to the metal rings 250 and 260, and couple between the cylindrical metal layer 150 included in the lens barrel 100 and the metal rings 250 and 260.

By continuously disposing the solder layer SL between the metal layer 150 inserted into the lens barrel 100 and the metal rings 250 and 260 inserted into the lenses L1 and L3, a gap between the lens barrel 100 and the lenses L1 and L3 may be sealed by the metal layer 150, the metal rings 250 and 260, and the solder layer SL coupling between the metal layer 150 and the metal rings 250 and 260.

Specifically, at both side openings in the optical axis OA direction of the lens barrel 100, in the example of an object-side opening, the opening may be surrounded and sealed by the metal layer 150 of the lens barrel 100, the first metal ring 250 of the foremost lens L1, the solder layer SL between the metal layer 150 and the first metal ring 250, and the foremost lens L1 formed of glass. Additionally, in the example of the image sensor side opening in the lens barrel 100, the opening may be surrounded and sealed by the metal layer 150 of the lens barrel 100, the second metal ring 260 of the rearmost lens L3, a solder layer SL between the metal layer 150 and the second metal ring 260, and the rearmost lens L3 formed of glass.

The lens module 1000 according to the one or more examples may improve a degree of sealing inside the lens barrel 100 through this structure, compared to examples using an O-ring formed of rubber or silicone and a retainer for compressively fixing the O-ring. Additionally, the metal layer 150 and the metal rings 250 and 260 coupled with the solder layer SL may have higher durability than the O-ring formed of rubber or silicone, and may maintain the sealed state inside the lens barrel 100 for a longer period of time.

Referring to FIGS. 2 and 5, the solder layer SL may be disposed between the first metal ring 250 included in the foremost lens L1 and the metal layer 150 included in the lens barrel 100, and between the second metal ring 260 included in the rearmost lens L3 and the metal layer 150 included in the lens barrel 100.

As an example of a forming process of the solder layer SL, a solder plate or a ring-shaped solder preform may be disposed between the metal rings 250 and 260 and the metal layer 150, and the solder layer SL may be formed through induction heating. When induction heating is used to form a solder layer SL, the influence of heat on the lenses L1 and L2 may be minimized by locally generating an induced current in the solder plate or solder preform disposed between the metal rings 250 and 260 and the metal layer 150 to heat them. The solder layer SL may include at least one of Sn, Pb, Ag, and Cu, but is not limited thereto.

In an example, the coupling between the metal rings 250 and 260 and the metal layer 150 may be formed by welding between metals through heating and pressurization in addition to soldering, and bonding using metal paste may also be possible.

Referring to FIGS. 2 and 5, the lens module 1000, in accordance with one or more embodiments, may further include respective lens caps 310 and 320. Specifically, a first lens cap 310 which is coupled to the lens barrel 100 to cover an external surface of the foremost lens L1, and a second lens cap 320 which is coupled to the lens barrel 100 to cover an external surface of the rearmost lens L3 may be included.

The lens caps 310 and 320 may have an opened shape on both sides. Therefore, the foremost lens L1 may be exposed to an object side through a first side of the first lens cap 310, and a second side of the first lens cap 310 may be coupled with the lens barrel 100. Additionally, the rearmost lens L3 may be exposed to the image sensor side through a first side of the second lens cap 320, and a second side of the second lens cap 320 may be coupled with the lens barrel 100.

One side of the first lens cap 310 may extend to a direction toward the center of the foremost lens L1 to cover a portion of the external surface of the foremost lens L1.

The second side of the first lens cap 310 may extend in the same direction as an extended direction of the lens barrel 100 to cover a portion of a side surface of the lens barrel 100. Additionally, one side of the second lens cap 320 may extend to a direction toward the center of the rearmost lens L3 to cover a portion of the external surface of the rearmost lens L3. The other side of the second lens cap 320 may extend in the same direction as an extended direction of the lens barrel 100 to cover a portion of the side surface of the lens barrel 100.

The lens caps 310 and 320 may be coupled to the lens barrel 100 by various mechanical connection methods. For example, the lens caps 310 and 320 and the lens barrel 100 may be coupled to each other through a screw structure. Screw threads may be formed on an internal side surface of the lens caps 310 and 320 and an external side surface of the lens barrel 100, respectively, and the screw threads of the lens caps 310 and 320, and the screw threads of the lens barrel 100 may be engaged and fixed. According to this structure, the positions of the lens cap 310 and 320, and the positions of the foremost lens L1 and the rearmost lens L3 in contact with the lens caps 310 and 320 may be finely adjusted, thereby facilitating focus and optical axis alignment of the lens module 1000. Additionally, even if impact or vibration occurs through anti-loosening treatment after coupling the screw, the coupling between the lens caps 310 and 320 and the lens barrel 100 may be maintained stably and firmly. Additionally, the lens caps 310 and 320 and the lens barrel 100 may be easily separated and reassembled when necessary.

However, a method of coupling between the lens caps 310 and 320 and the lens barrel 100 is not limited to a method of coupling using a screw structure, and various methods such as, but not limited to, a clip coupling method using tabs or protrusions, a fitting method using press-fitting, and an adhesion method using an adhesive may be used.

Although not illustrated in the drawings, the joint region between the lens caps 310 and 320 and the lens barrel 100 may further include a sealing member. The sealing member may be, as only examples, rubber, silicone, or epoxy adhesive, or the like, but is not limited thereto. When the sealing member is further included in the joint region between the lens caps 310 and 320 and the lens barrel 100, a first sealing structure through the sealing member and a second sealing structure through the solder layer SL between the metal layer 150 and the metal rings 250 and 260 may be provided, so that the effect of preventing moisture penetration into the lens barrel 100 may be further improved.

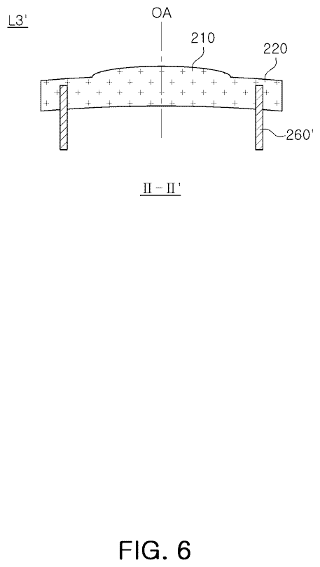

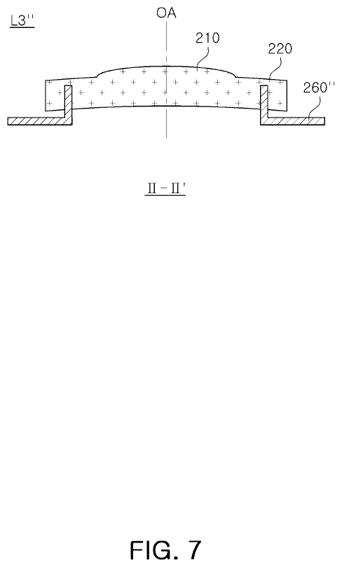

FIGS. 6 and 7 are modified examples L3′ and L3″ of the rearmost lens of FIG. 4. In FIGS. 6 and 7, the second metal ring 260 of the rearmost lens L3 of FIG. 4 is illustrated in a deformed form, but this is only an example, the first metal ring 250 of a foremost lens L1 may also be similarly deformed.

Referring to FIG. 6, the rearmost lens L3′ according to the present modified example may include a metal ring 260′ disposed within the rib 220 along the periphery and extending at least a portion thereof externally of the rearmost lens L3′, and the metal ring 260′ may extend in the direction of the optical axis OA. That is, the metal ring 260′ of this modified example may correspond to a side surface of a cylindrical shape centered on the optical axis OA.

In the example of the metal ring 260′ of the modified example, by extending the metal layer 150 of the lens barrel 100 to an external side surface of the metal ring 260′ in the optical axis OA direction and coupling it through the solder layer SL, the waterproof and moisture-proof performance of the lens module 1000 in the side-surface direction may be improved. Additionally, as the metal ring 260′ extends in the optical axis OA direction, an image quality may be improved by minimizing reflection from the metal ring 260′ of some light incident on the rib 220.

Referring to FIG. 7, a rearmost lens L3″ according to the present modified example may include a metal ring 260′′ disposed within the rib 220 along the periphery and extending at least a portion thereof externally of the rearmost lens L3″, and the metal ring 260″ may extend in the optical axis OA direction and may be bent in a direction perpendicular to the optical axis OA.

In the example of the metal ring 260′′ of the modified example, the moisture penetration prevention effect may be improved as the area that may be coupled with the metal layer 150 through the solder layer SL increases. Additionally, by changing the bending position of the metal ring 260″, position of the rearmost lens L3″ in the optical axis direction and an adjustment of the coupling area with the metal layer 150 may be possible, thereby increasing a degree of design flexibility. Additionally, the coupling area of the metal ring 260″ and the metal layer 150 may be spaced apart from the rearmost lens L3″, so that lens deformation during the coupling process may be minimized.

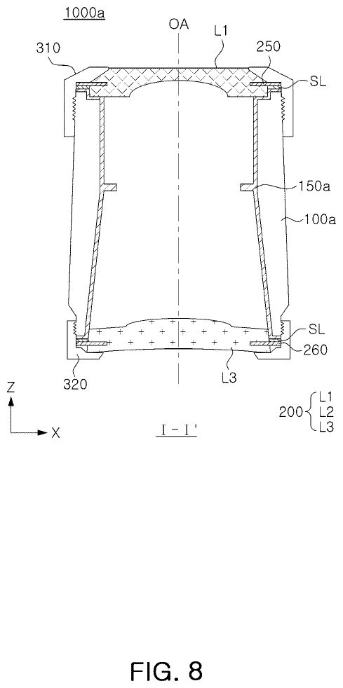

FIGS. 8 to 10 are modified examples 1000a, 1000b, and 1000c of the lens module 1000 of FIG. 2. In an example, in order to clearly illustrate a deformation form of the lens barrel 100 and the metal layer 150, the middle lens L2 and the spacer SP are omitted and illustrated in FIGS. 8 to 10.

Referring to FIG. 8, a metal layer 150a of a lens module 1000a according to the present modified example may be disposed on an internal surface of a lens barrel 100a. That is, the metal layer 150a may be disposed along a shape of an internal space of the lens barrel 100a and may be coupled with the first metal ring 250 and the second metal ring 260 through the solder layer SL, respectively.

The metal layer 150a of the present modified example may be formed integrally with the lens barrel 100a through a double injection process using, for example, at least one metal component among Ni, Cu, SUS, Al, Mg, and Ti and a plastic resin component. Alternatively, the metal layer 150a of the present modified example may be formed by coating the internal surface of the lens barrel 100a formed of plastic resin with a metal including at least one of Ni, Cu, SUS, Al, Mg, and Ti.

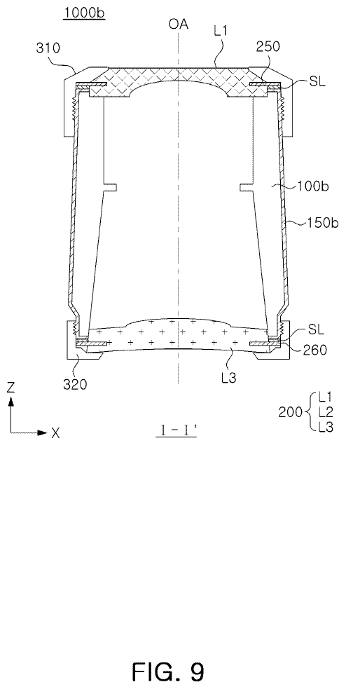

Referring to FIG. 9, a metal layer 150b of a lens module 1000b according to the present modified example may be disposed on an external surface of a lens barrel 100b. That is, the metal layer 150b may be disposed along an external side shape of the lens barrel 100b and may be coupled with the first metal ring 250 and the second metal ring 260 through the solder layer SL, respectively.

The metal layer 150a of the present modified example may be integrally formed with the lens barrel 100b through a double injection process using, for example, at least one metal component among Ni, Cu, SUS, Al, Mg, and Ti and a plastic resin component. Alternatively, the metal layer 150b of the present modified example may be formed by coating the external surface of the lens barrel 100a formed of plastic resin with a metal including at least one of Ni, Cu, SUS, Al, Mg, and Ti.

In the example of the lens barrel 100b of the modified example, since the metal layer 150b and the lens portion 200 may not come into contact with each other in the internal space of the lens barrel 100b, a risk of lens deformation or optical axis OA misalignment due to differences in thermal expansion rates between plastic and metal may be reduced.

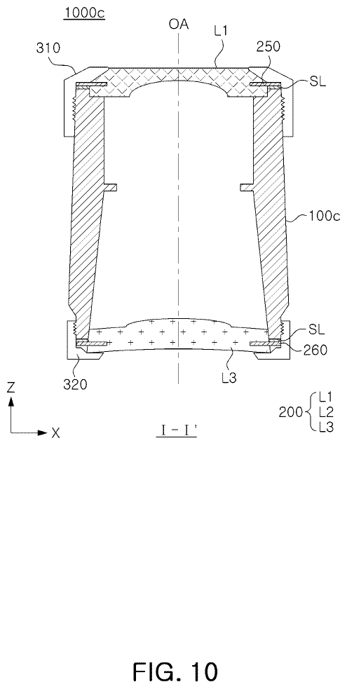

Referring to FIG. 10, a lens barrel 100c of a lens module 1000c according to the modified example may be formed of a metal material. That is, the lens barrel 100c of the present modified example may not include a separate metal layer, and the lens barrel 100c itself may be formed of a metal material. For example, the lens barrel 100c of the present modified example may be formed of at least one metal among Ni, Cu, SUS, Al, Mg, and Ti.

In the example of the lens barrel 100c of the modified example, the lens barrel 100c may be directly connected to the metal rings 250 and 260 of the lenses L1 and L3 through the solder layer SL.

A lens barrel 200c of the present modified example may be formed by, for example, metal injection molding, but is not limited thereto, and may also be formed through processes such as computer numerical control (CNC) machining, die casting, and extrusion, as only examples.

The lens barrel 200c of the modified example may have a simplified manufacturing process compared to double injection molding. Additionally, since the lens barrel 200c of this modified example is formed of a metal material, it may have a lower thermal expansion rate than a plastic material so it may have excellent thermal stability and high durability.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A lens module, comprising:
a lens barrel including a metal layer;
a lens unit, disposed in the lens barrel, and including a plurality of lenses having an effective diameter and a rib;
a metal ring disposed within the rib of at least one lens of the plurality of lenses, and at least a portion of the metal ring extends from an external side of the at least one lens; and
a solder layer disposed between the metal layer and the metal ring.

2. The lens module of claim 1, wherein the solder layer is continuously disposed along a periphery of the metal ring.

3. The lens module of claim 1, wherein the metal layer is disposed within the lens barrel and at least a portion of the metal layer is exposed externally of the lens barrel.

4. The lens module of claim 1, wherein the lens unit comprises a foremost lens that is disposed closest to an object side and a rearmost lens that is disposed closest to an image sensor side.

5. The lens module of claim 4, wherein at least one of the foremost lens and the rearmost lens is a glass lens.

6. The lens module of claim 4, wherein the lens unit further comprises at least one intermediate lens that is disposed between the foremost lens and the rearmost lens.

7. The lens module of claim 6, wherein the intermediate lens comprises a plastic lens.

8. The lens module of claim 1, wherein a gap that is formed between the lens barrel and the at least one lens is sealed by the metal layer, the metal ring, and the solder layer, which forms a coupling between the metal layer and the metal ring.

9. The lens module of claim 1, wherein the metal layer is disposed on an internal surface of the lens barrel.

10. The lens module of claim 1, wherein the metal layer is disposed on an external surface of the lens barrel.

11. The lens module of claim 1, wherein the metal ring extends in a direction perpendicular to an optical axis.

12. The lens module of claim 1, wherein the metal ring extends in an optical axis direction.

13. The lens module of claim 1, wherein the metal ring extends in an optical axis direction, and is further bent in a direction perpendicular to the optical axis.

14. The lens module of claim 1, wherein the metal layer and the metal ring respectively comprise at least one of Ni, Cu, SUS, and Al.

15. A lens module, comprising:
a lens barrel formed of metal material;
a lens disposed in the lens barrel and comprising an effective diameter and a rib; and
a metal ring disposed within the rib, and at least a portion of the metal ring extends from an external side of the lens;
wherein a solder layer coupling is formed between the lens barrel and the metal ring.

16. The lens module of claim 15, wherein the lens barrel is formed of at least one metal among Ni, Cu, SUS, and Al.
